(19) United States
(12) Patent Application Publication
(10) Pub. No.: US 2008/0046935 A1
(43) Pub. Date: Feb. 21, 2008

(54) SYSTEM AND METHOD FOR DISPLAYING PROGRAM GUIDE INFORMATION

(76) Inventor: Haig H. Krakirian, Burbank, CA (US)

Correspondence Address: ROPES & GRAY LLP, PATENT DOCKETING 39/361, 1211 AVENUE OF THE AMERICAS, NEW YORK, NY, 10036-8704, US

(21) Appl. No.: 11/465,629

(22) Filed: Aug. 18, 2006

(51) Int. Cl. H04N 7/173; H04N 5/445; G06F 13/00; G06F 3/00

(52) U.S. Cl. 725/87; 725/39; 725/61; 725/86; 725/45

(57) ABSTRACT

A system and method for displaying program guide information from multiple sources, including second level information, in response to a first request for program guide information.

### RELATED APPLICATIONS

All references cited in this application are hereby incorporated herein by reference, including but not limited to all U.S. patent applications and patents, and specifically U.S. patent application Ser. No. 11/277,347, filed the same day as the present application, with the same named inventor(s) and owned by the same assignee, entitled System and Method for Selectively Recording Program Content from a Mosaic Display (hereafter the “Mosaic Application”).

### FIELD OF THE INVENTION

The present invention relates generally to displaying program guide information, and more particularly, to systems and methods for selectively displaying program guide information including second level information, program guide information from multiple sources, and program guide information meeting specific user criteria.

### BACKGROUND

There currently exists a significant variety of program sources for television viewers. “Television” is used herein to mean any program viewing device capable of displaying program guide information, which includes: a common television set; an HD TV set; a computer display; and a remote control with video display capability; a phone, personal digital assistant (PDA), IPOD, or other mobile device capable of video display. Television viewers may watch programs from such sources as broadcast service providers (including network, cable, and satellite providers), Video-On-Demand (VOD) service providers, and media players such as digital video recorders (DVRs), video cassette recorders (VCRs), and DVD players. With all of these program sources, it would be helpful for the user to have a system for receiving and displaying information from multiple sources so that program guide information from the multiple sources could be displayed on a single program guide display.

Currently, a user may receive information on available programs by submitting a request to a television viewing system. The program guide information requested is typically displayed on the viewing system, and the program guide information corresponds to channels available to the user. However, one shortcoming with typical program guides is that they generally do not show information from different sources at the same time. For example, if the user has programs recorded on a DVR, those programs are not displayed in the program guide alongside the available broadcast programs. The user has to submit an additional request for information in order to see what DVR programs are available. Likewise, when the user is viewing information on the available DVR programs, the user cannot simultaneously view information on available broadcast programs, for which the user will again have to submit an additional request.

Regarding certain other programs, in order to see what programs are available, the user usually has to first submit a request to view the parent information associated with the programs, followed by additional requests to see a list of the programs available for viewing through the selected service. The program information that is available on specific available programs, only after going through the parent program link/menu option, is referred to herein as “second level information”. The “first request” as referred to above and as used herein, including in the claims, occurs when there is no other program guide information being displayed. An example schematic of this is shown in FIG. 6, using the HBO VOD service as an example. In FIG. 6, the user may be required to submit the first request to select an On Demand channel 601 (the parent program) from a typical program guide, then select the HBO channel 602a from a list 602 of available On Demand services, then select from subcategories 603 of programs available from HBO On demand (e.g., Series, Kids, etc.), then select from other subcategories 604 (e.g., if Series was chosen, then available options might be Curb Your Enthusiasm, The Sopranos; and Six Feet Under), and then select from the specific episodes 605 of the selected series (e.g., episode number 1 from season 1). The ultimate programs available 605 (e.g., The Sopranos, season 1, episode 1; The Sopranos, season 1, episode 2, . . . ) are referred to herein as second level programs, and the information associated with them is referred to as “second level information”, to distinguish them from the parent program and information that must be passed through first on a menu or guide. Typically, the second level information (i.e., the actual list of HBO programs in the above example) cannot be viewed simultaneously with lists of programs from other sources, such as broadcast programs. The present invention overcomes (as shown in FIG. 2) this shortcoming of the prior art, as discussed more fully herein.

Furthermore, the program guide information usually only provides “blanket” program guide information without allowing the user to provide any specific user criteria for viewing the program guide information. Thus, if the user wishes to view only what cartoon programs are available, the user will have to sort through program guide information for a large number of programs in order to find the cartoon programs.

It is therefore desirable to provide systems and methods for displaying program guide information gathered from multiple sources, all on the same display, including second level information and program guide information displayed in response to user criteria and other specifications.

### SUMMARY OF THE INVENTION

The present invention allows a user to view program guide information associated with programs from one or more sources. The sources may include, for example, broadcast service providers, video-on-demand (VOD) service providers, and/or media players. A system embodying the present invention includes a receiving unit for receiving program guide information from the sources, and a display unit for displaying the program guide information.

A user wishing to view program guide information may submit to the system a first request requesting program guide information. The receiving unit receives the first request and responds by causing program guide information to be displayed on a display device. The program guide information includes information on programs available to the user from multiple sources, including second level information. Thus, the present invention eliminates the need for the user to submit additional requests to receive second level information. Another feature of the present invention is that the program guide may include program guide information from multiple sources, such as broadcast service providers, VOD service providers, and media players such as DVRs.

The program guide information may also correspond to specific user criteria, such as a request for a program category. An example of a category may be sports, such that the program guide information will include all programs (from multiple sources) featuring sports. The user criteria may also include specific elements, such as a title or an actor/actress, producer, TV ratings, and/or parental controls.

The program guide information may also be customized to be displayed in a desired format. For example, the program guide information may be customized to be displayed for a specific time slot, or in a specific sort order.

Other aspects and features of the present invention will become apparent from consideration of the following description taken in conjunction with the accompanying drawings.

### BRIEF DESCRIPTION OF THE DRAWINGS

FIG. 1 is a schematic illustration of a system for receiving and displaying program guide information in accordance with the present invention.

FIG. 2 is an illustration of a program guide displayed in accordance with the present invention.

FIG. 3. is a flowchart showing a method for receiving and viewing program guide information in accordance with the present invention.

FIG. 4 is a flowchart showing a method for receiving and viewing program guide information displayed with user criteria in accordance with the present invention.

FIG. 5 is a flowchart showing a method for customizing program guide information in accordance with the present invention.

FIG. 6 is a schematic illustration of how second level information is typically accessed in the prior art.

### DETAILED DESCRIPTION OF THE PREFERRED EMBODIMENTS

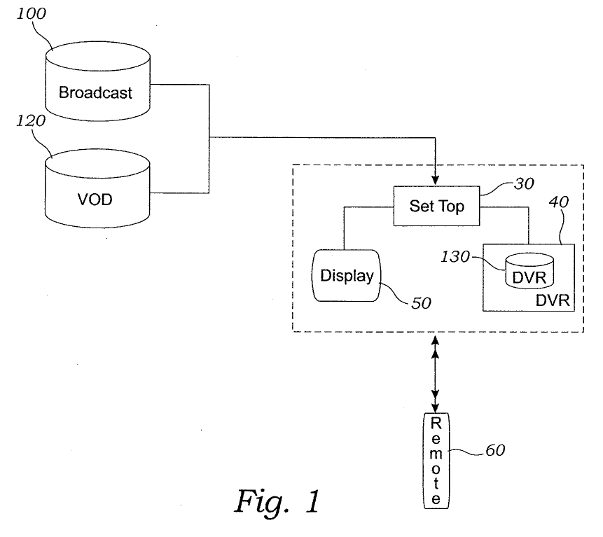

FIG. 1 illustrates a physical embodiment of the invention, showing a system 10 that allows a user to view programs in a single guide from one or more sources. The sources are shown as separate databases, but it is understood by those skilled in the art that the sources may be in any format suitable for processing, including in a single database, and may be located either remotely (e.g., at a broadcast service provider in a remote storage device) and/or locally (e.g., typically a media player such as a DVR at a user's home in a local storage device). The databases may contain program guide information related to channels featuring programs, program content, program viewing times, programs available for a fee (e.g., pay per view), and any other relevant information as may be determined by the service provider, and/or desired.

The system 10 includes a receiving unit, e.g., a set-top box 30, for receiving the program guide information. The program guide information may be received from one or more sources, such as the program providers' databases. The content of the program guide information received from the databases may depend upon the program services subscribed to by the user. For example, a user subscribing only to broadcast programming services may receive program guide information from a broadcast program database 100. Likewise, a user subscribing to a VOD service may receive program guide information from a VOD service provider's database 120 in accordance with the VOD services subscribed to. Additionally, the system 10 may include a media player such as a DVR 40, such that program guide information stored in a DVR program database 130 may also be received by the set-top box 30.

The set-top box 30 sends the received program guide information to a display unit 50, typically a television set. A remote control device 60 may interact (either 1-way or 2-way) with the system 10 to access the program guide information. Other interactive devices, such as a keyboard, may also be used in place of the remote control device 60. The remote control device 60 interacts with the system 10 by requesting such functions as identifying, selectively viewing, and searching through the program guide information, along with applying any other features provided by the system 10 and/or the remote control device 60.

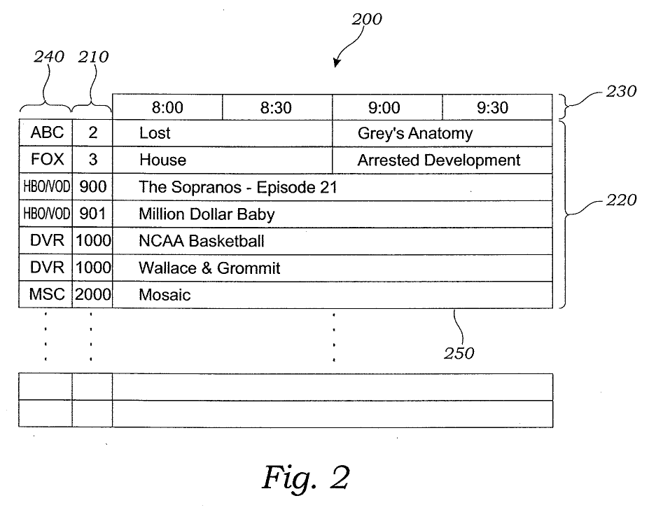

In one embodiment of the invention, the system 10 receives a first request from the user requesting program guide information. The first request may include user criteria, such as a general request for program guide information, or a request for more specific program guide information, as discussed herein. The first request is typically submitted with the remote control device 60. The set-top box 30 then causes program guide information that meets the criteria of the first request to be displayed on the display unit 50, as program guide 200 (FIG. 2). An illustration of the program guide 200, as it may be displayed, is shown in FIG. 2. The contents of the program guide 200 include information received by the set-top box 30 from the program sources, such as a broadcast program database 100, a VOD program database 120, or a DVR program database 130.

The program guide 200 preferably includes information on all programs available to the user, from all sources available to the system. The program guide 200 also preferably includes second level information, thereby eliminating the need for the user to submit additional requests to receive the second level program guide information.

Without the system 10, the user would normally have to submit one request to request program guide information, and at least one additional request to see what programs were available for viewing through the parent program. The system 10, however, requires only the first request and then displays the program guide 200 that includes second level information.

Referring again to FIG. 2, the program guide 200 generally includes a channel list 210 and a corresponding program list 220. The channel list 210 may include all publicly available channels, and also other channels to which a user may subscribe. The program list 220 may be arranged according to time slots 230 in which the programs are shown. For example, the program guide 200 may display all of the programs that can be viewed on channels 1-50 at 8:00 PM. The program guide 200 may also display additional information about each program, such as its rating (e.g., R or PG), its running time, and/or its content.

Another feature of the program guide 200 is that it may simultaneously display information from multiple sources. To illustrate, one of these sources may be the broadcast program database 100. The set-top box 30 receives and stores broadcast program guide information from the broadcast program database 100. The broadcast program guide information may include a list of programs featured on a broadcast channel, the programs' corresponding time slots, and details of the programs' content. When the set-top box 30 receives the first request from the user, the set-top box 30 causes the program guide 200 to be displayed with the broadcast program guide information from the broadcast program database 100. For example, as shown in FIG. 2, the program guide 200 may display the programs on ABC and FOX at 8:00 PM.

Similarly, the VOD program database 120 may be another one of the multiple sources for the program guide 200. The set-top box 30 receives and stores the VOD program guide information from the VOD program database 120. When the set-top box 30 receives the first request from the user, the set-top box 30 then causes the program guide 200 to be displayed with the VOD program guide information from the VOD program database 120, and preferably including all of the available VOD second level information. Additionally, the program guide 200 may display the VOD program guide information along with program guide information from other sources. Using the same example, as shown in FIG. 2, the program guide 200 may display the broadcast program guide information, such as the programs available on ABC and FOX at 8:00 PM, along with all of the available HBO VOD programs (for simplicity, only The Sopranos episode 21 on channel 900, and Million Dollar Baby on channel 901 shown in FIG. 2). Because the VOD programs may be viewed at any time, the program guide 200 may display the VOD programs as being available during all time slots, as shown in FIG. 2.

Another source for the program guide information may be a media player database such as a DVR program database 130 (or even a DVD, CD, or VCR database with information on currently loaded DVDs, CDs, and/or VCRs). When the DVR records and stores programs on the DVR program database 130, the set-top box 30 may then receive information on the DVR-recorded programs from the DVR program database 130. When the set-top box 30 receives the first request from the user for program guide information, the set-top box 30 then causes the program guide 200 to be displayed with the DVR program guide information from the DVR program database 130, including preferably all of the available DVR programs. In the same manner as with the VOD programs, the system 10 eliminates the need to submit additional requests in order to display the available DVR programs. Additionally, the program guide 200 may display the DVR program guide information along with program guide information from the other program sources. For example, as shown in FIG. 2, the program guide 200 may display: broadcast program guide information, such as the programs available from ABC and FOX at 8:00 PM; the available HBO VOD programs (shown as The Sopranos episode 21, and Million Dollar Baby in FIG. 2), and the available DVR programs (shown as NCAA Basketball, and Wallace & Grommit, in FIG. 2). Similar to the VOD programs, the DVR programs may be displayed on the program guide 200 as being available during all time slots, because the DVR programs may be viewed at any time.

The program guide 200 may also display a source identifier 240 for each of the listed programs. The source identifier 240 may be shown in a column adjacent to the program list 220, and may be text, graphics, video, or a combination thereof. For example, each broadcast program listing may be accompanied by the source identifier 240 that identifies the corresponding broadcast provider, such as “ABC” or “FOX.” The source identifier 240 may also be used for cable network providers, such as “ESPN” or “HBO.” Likewise, each VOD program listing may have the source identifier 240 “VOD” or a more specific source identifier 240 such as “HBO VOD.” Furthermore, each DVR program listing may be accompanied by the source identifier 240 “DVR,” or if multiple DVRs are available, then by an appropriate identifier for each such as DVR1, DVR2, etc.

The program guide 200 may also list a mosaic program channel 250, in which a number of programs may be concurrently displayed in the form of a mosaic. For example, the mosaic program channel 250 may simultaneously feature a number of “thumbnail,” or reduced-size, views of several programs on the same display screen. The mosaic program channel 250 may allow for viewing multiple programs on the same display, in addition to applying a function to another program, such as recording, on the same display. The mosaic program channel 250 may also be accompanied by its own source identifier 240, such as “MSC.” The Mosaic Application referred to under the RELATED APPLICATIONS section of this application describes mosaic displays and their functionality in more detail.

Another feature of the system 10 is that the program guide 200 may correspond to specific user criteria, such as program guide information for a category of programs. The user criteria may be created by using the remote control device 60 to select the user criteria. In one embodiment, the user criteria may be selected through a selection menu provided by the system 10. The selection menu may appear on the display device for interaction with the remote control device 60, or on another interactive device, including the remote control 60 itself. The user criteria may then be submitted to the system 10 as part of the first request. The user criteria may also be created after submitting the first request.

In one embodiment of the present invention, the set-top box 30 receives the user criteria and then causes the program guide 200 to display information from multiple sources, if available, according to the user criteria. For example, if the user criteria in the first request includes a request for programs in the sports category, the program guide 200 will provide a program list 220 of all available sports programs, including: all of the sports programs from broadcast service providers; all of the VOD programs featuring sports; and all of the available DVR programs and other pre-recorded programs on other media devices featuring sports.

The user criteria may also include more specific elements or subject matter, such as a title, an actor/actress, a time slot, or even a selection of sources. For example, the user criteria may include a request for all currently available programs featuring John Travolta. The program guide 200 would then provide a program list 220 of all programs featuring John Travolta from all of the available program sources.

The first request may also have user criteria combining multiple elements as part of a Boolean logic operation. For example, if the user criteria includes a request for all action programs featuring John Travolta, the program guide 200 would include a program list 220 of all available action programs featuring John Travolta (i.e., a logical “and” operation). Also for example, if the user criteria includes a request for all programs that are either action programs or programs with John Travolta, the program guide 200 would include a program list 220 of all action programs and all John Travolta programs combined (e.g., a logical “or” operation). Other basic logic functions may also be implemented to allow the user more control over user-selected criteria.

Another feature of the system 10 is that the program guide 200 may be customized to be displayed in a desired format. For example, the program guide 200 may be customized to display a maximum of two hours of time slots. As another example, the program guide 200 may be customized to display information in various sort orders. The program guide 200 may be customized by using the remote control device 60. In one embodiment, the program guide 200 may be customized through a customization menu provided by the system 10. The customization menu may appear on the display device 50 to allow interaction with the remote control device 60, or on the remote control 60 itself, or on another display. After the program guide 200 is customized, the set-top box 30 will then cause the program guide 200 to be displayed in accordance with the customization.

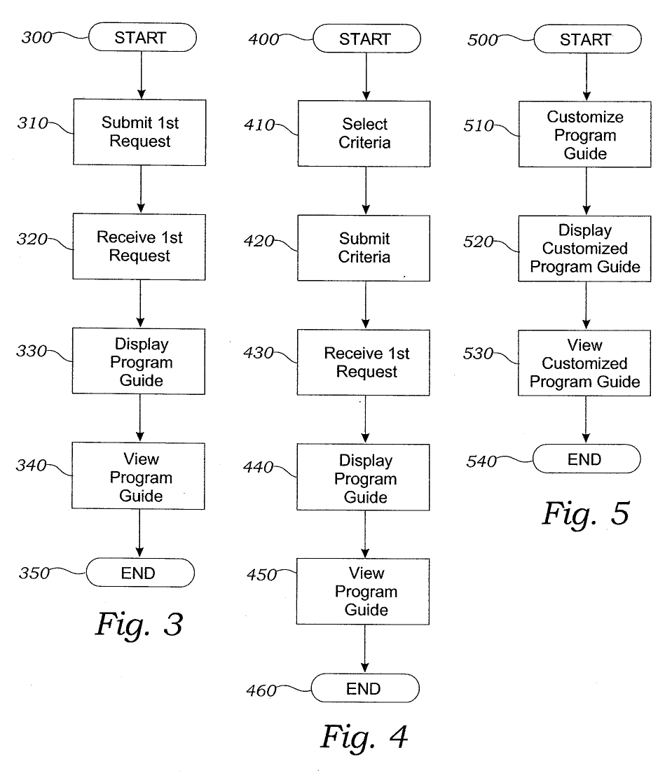

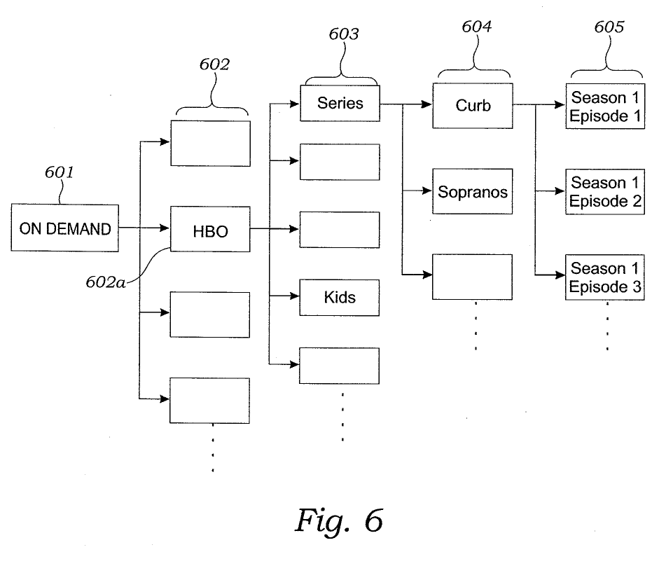

FIG. 3 illustrates a method of using the system 10, starting at step 300. At step 310, a user requests program guide information by submitting the first request to the system 10. At step 320, the set-top box 30 receives the first request and, as shown in step 330, responds by causing the program guide 200 to be displayed on the display device 50. Next, at step 340, the user views the program guide 200 to see program guide information from multiple sources, such as a broadcast program database 100, a VOD program database 120, and/or a DVR program database 130. The user will also be able to view second level information on all available programs, such as VOD programs and DVR programs. The method of FIG. 3 ends at step 350.

FIG. 4 shows a method, starting at step 400, for the user to view more specific program guide information, such as information on all programs featuring cartoons, by including specific user criteria in the first request. At step 410, the user may select the user criteria for cartoons from a selection menu, which may appear on the display device 50. As shown at step 420, the user criteria may be submitted with the first request. At step 430, the set-top box 30 receives the first request. The set-top box 30 responds, as shown at step 440, by causing the program guide 200 to be displayed on the display device 50 listing all programs matching the user criteria. Next, at step 450, the user may view the program guide 200 matching the selection criteria on the display device 50. The method of FIG. 4 ends at step 460.

FIG. 5 shows a method, starting at step 500, for the user to customize the program guide 200. At step 510, the user may customize the program guide 200 (e.g., by using the remote control device 60) to make selections from a customization menu, which may appear on the display device 50. At step 520, the set-top box 30 displays the program guide 200 in accordance with the customized format. The user may then view the customized program guide 200, as shown at step 530, and make any customization changes as desired. The method of FIG. 5 ends at step 540.

While specific examples of the invention have been shown in the drawings and are herein described in detail, the invention is susceptible to various modifications and alternative forms. For example, the VOD source and the broadcast service provider source may both be located at the same service provider. Also for example, other sources not specifically named herein may also be used in connection with the present invention, such as a Pay-Per-View source. Therefore, it should be understood that the invention is not to be limited to the particular forms or methods disclosed, but to the contrary, the invention is to cover all modifications, equivalents, and alternatives falling within the scope of the appended claims.

What is claimed is:

1. A method for displaying program guide information on a display device, the method comprising:
receiving a first request for program guide information, wherein the first request comprises user criteria; and
displaying on a display device, in response to the first request, the program guide information according to the user criteria, the program guide information comprising second level information.

2. The method of claim 1, wherein the program guide information further comprises a source identifier.

3. The method of claim 1, wherein the program guide information comprises broadcast program guide information.

4. The method of claim 3, wherein the second level information comprises Video-On-Demand (VOD) program guide information.

5. The method of claim 4, wherein the program guide information comprises Digital Video Recorder (DVR) program guide information.

6. The method of claim 3, wherein the program guide information comprises Digital Video Recorder (DVR) program guide information.

7. The method of claim 1, wherein the second level information comprises Video-On-Demand (VOD) program guide information.

8. The method of claim 7, wherein the program guide information comprises Digital Video Recorder (DVR) program guide information.

9. The method of claim 1, wherein the program guide information comprises Digital Video Recorder (DVR) program guide information.

10. The method of claim 1, wherein the program guide information comprises information for a mosaic program channel.

11. The method of claim 1, wherein the program guide information comprises information from a local storage device and information from a remote storage device.

12. The method of claim 1, wherein the program guide information further comprises a source identifier.

13. The method of claim 1, wherein the step of displaying the program guide information comprises displaying the program guide information in a customized format.

14. The method of claim 1, wherein the program guide information is from multiple sources.

15. A method for receiving program guide information, the method comprising:
submitting a first request for program guide information; and
receiving the program guide information, wherein the program guide information comprises second level information and is from multiple sources.

16. The method of claim 15, wherein one of the multiple sources comprises a broadcast program source.

17. The method of claim 16, wherein one source of the second level information is a Video-On-Demand (VOD) source.

18. The method of claim 16, wherein one source of the second level information is a Digital Video Recorder (DVR) source.

19. The method of claim 13, wherein the first request comprises user criteria.

20. The method of claim 19, wherein the user criteria comprises a program category.

21. The method of claim 19, wherein the user criteria comprises a time slot.

22. The method of claim 19, wherein the user criteria comprises a sort order.

23. The method of claim 19, wherein the user criteria is determined based at least partly on a Boolean operation.

24. A system for displaying program guide information, comprising:
an interactive device;
a display device; and
a receiving unit in communication with the display device and capable of receiving commands from the interactive device, the receiving unit further being capable of receiving program guide information from multiple sources, including second level information, and of causing the program guide information from the multiple sources, including the second level information, to be displayed on the display device in response to a first request from the interactive device.

25. The system of claim 24, wherein one of the sources is a Digital Video Recorder (DVR).

26. The system of claim 25, wherein one of the sources is a Video On Demand (VOD) source.
